(19) United States
(12) Patent Application Publication
(10) Pub. No.: US 2004/0098488 A1
(43) Pub. Date: May 20, 2004

(54) Network-assisted communication method and system therefor

(76) Inventor: William Mayers, Montreal (CA)

Correspondence Address: RYAN KROMHOLZ & MANION, S.C., POST OFFICE BOX 26618, MILWAUKEE, WI, 53226, US

(21) Appl. No.: 10/466,273

(22) PCT Filed: Jan. 18, 2002
(86) PCT No.: PCT/CA02/00072

(51) Int. Cl. G06F 15/16

(52) U.S. Cl. 709/228; 709/246

(57) ABSTRACT

A computer network-assisted communication method and system that allows the establishment of a communication link on a network, such as the Internet, between a first communication device and other communication devices, and allows discussion through the exchange of phonic phrase groups (PPG™s). The PPG™s creation process includes capturing a communication contribution by one of the communication participants, and appending tags that characterize the contribution. The tags allow the sorting and management of communication contributions through the use of a user-interface.

### FIELD OF THE INVENTION

The present invention relates to a system and method for the management of communications. More specifically, the present invention is concerned with a system and method for the management of communications through a network.

### BACKGROUND OF THE INVENTION

Since the advent of language, man has striven to improve his ability to communicate with others over distance and time. Related inventions have followed two distinct paths.

The first path is that of messaging, which can be summarized as non-interrupted communication (asynchronous). Innovations in asynchronous message systems include the mail, the telegraph, telex, facsimile, and email. Most of these messaging systems generally allow for the storage of the messages for future referral or response.

The second form of communication is conversational (synchronous). This form allows for interruptions of messages and the interactivity of participants. Technologies such as the telephone (wireless and connected) and video conferencing are able to allow for this type of real-time interactive response.

Numerous problems exist when employing either of these types of communication. In particular, in messaging systems, a significant portion of the message is used by the sender anticipating what the responder will need to know or what possible responses may be diverted. It may include elements that are of no importance to the audience, while omitting important elements. Additionally, since responses are not time dependent, efforts to focus a communication are not continuous, resulting in less efficient communication. Furthermore, in this communication mode, the lack of interruptions may result in a large amount of effort being wasted by the sender, since he cannot dynamically gauge the response of his audience in due time.

Interestingly, the reverse holds true in conversational modes of communication. More precisely, since the audience has the ability to interrupt at any time, should the audience be of any significant size, chaos ensues. Another major problem with this highly dynamic form of communication is the recording of individual voices and thoughts within the conversation for specific selective listening and replay.

A further problem that exists in remote communication lies in the difficulty to control the participants' communication behavior, and to assist in making it to the point of the matter in hand in order for the communication to be effective in the amount of time allotted to the speaker.

Recently a third mode of conversation system has arisen with the advent of computer networks, such as the Internet: instant messaging. On the one hand, this third type of system is similar to conventional intercom systems in that it allows creating a rapidly accessible semi-permanent communication link between two places and two people. This third mode of communication is analogous to the conversational mode in that they share similar characteristics and drawbacks.

In spite of the different modes considered above, a global problem remains based on the fact that all these forms of communication suffer from the inability to easily store and access at random locations of a conversation, or as in a non-sequential manner, i.e. threaded by topic or ideas.

### SUMMARY OF THE INVENTION

More specifically, in accordance with a first aspect of the present invention, there is provided a network-assisted communication method comprising:

establishing a communication link on a network between a first communication device and at least one other communication device;

capturing a communication contribution from the first communication device; and

converting the communication contribution into at least one phonic phrase group (PPG™) to be distributed on the network to the at least one other communication device; the at least one PPG™ including a data segment and at least one tag.

According to a second aspect of the present invention, a network-assisted communication system comprising:

at least one communication hub to be connected to a network for sending phonic phrase groups (PPG™s), and for receiving PPG™s from at least one communication device through the network; the communication hub being configured to convert a PPG™ into at least part of a communication contribution, and to convert a communication contribution into at least one PPG™; the at least one PPG™ including a data segment and at least one tag.

According to a third aspect of the present invention, there is provided a user-interface for a network-assisted communication system comprising:

interactive visual graphic means for capturing at least one multi-media segment from a communication contribution issued from a first communication participant;

interactive visual graphic means for converting the communication contribution into at least one phonic phrase group (PPG™), including means for assembling multi-media segments and for appending tags that characterize the communication contribution;

interactive visual graphic means for sending the at least one PPG™ to at least one other communication participant through a network;

interactive visual graphic means for receiving other PPG™s from the at least one other communication participant through the network; and

interactive visual graphic means for displaying at least one of the at least one PPG™ and the other PPG.

Other objects, advantages and features of the present invention will become more apparent upon reading the following non-restrictive description of preferred embodiments thereof, given by way of example only with reference to the accompanying drawings.

### BRIEF DESCRIPTION OF THE DRAWINGS

In the appended drawings:

FIG. 1 is a block diagram of a network-assisted communication system according to a first embodiment of the present invention, related to an Internet-based client service;

FIG. 2 is a schematic view of a user-interface for the agent servers from FIG. 1;

FIG. 3 is a flow chart of a network-assisted communication method according to an embodiment of the present invention;

FIG. 4 is a block diagram of a network-assisted communication system according to a second embodiment of the present invention, related to a master class; and

FIG. 5 is a block diagram of a network-assisted communication system according to a third embodiment of the present invention, related to discussion groups.

### DESCRIPTION OF THE PREFERRED EMBODIMENT

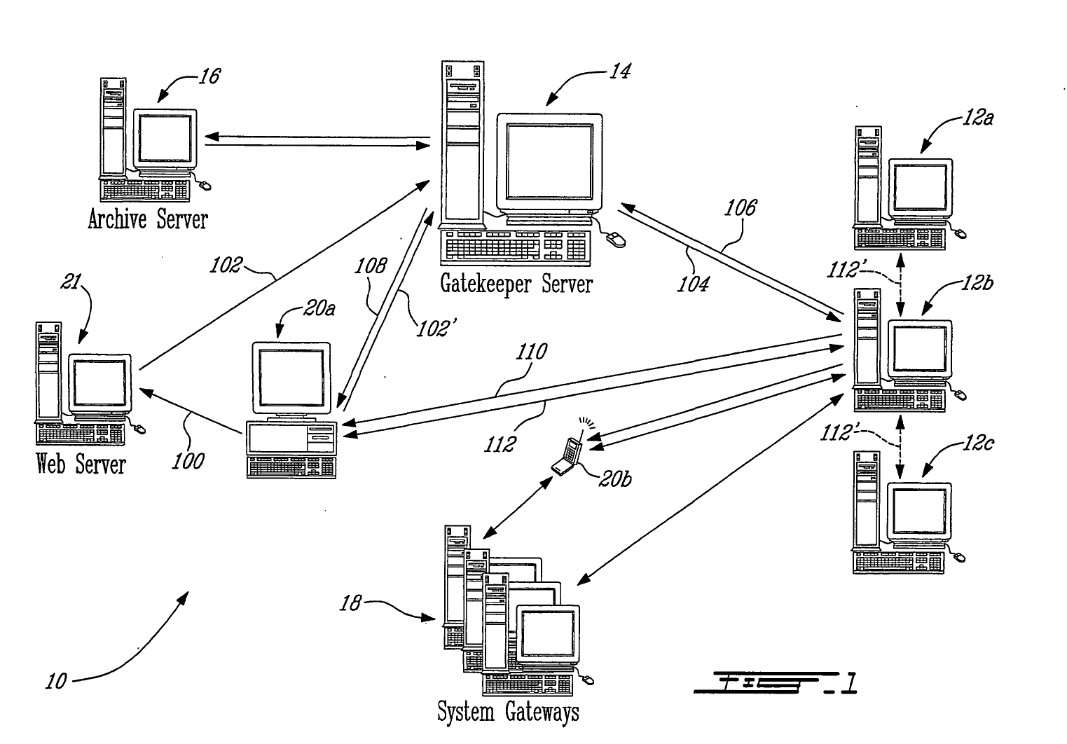

Turning now to FIG. 1 of the appended drawings, a network-assisted communication system 10 according to a first embodiment of the present invention will be described.

The network-assisted communication system 10 will be described in the context of an Internet-based consumer's help service.

The system 10 comprises a plurality of service agent servers 12, a controller server 14 in the form of a C3Gatekeeper™, an archive server 16, connected to the controller server 14, and system gateways 18 allowing connections between consumers' (or clients') communication devices 20 and the agent servers 12.

Before describing the operation and features of the communication system 10 in further detail, the connection process of its main components will first be described with reference to FIG. 1, where arrows are used to indicate actions in the process.

The communication devices 20 are provided with link functions, such as a conventional WEB browser, to remotely access a consumer's help service site (arrow 100), implemented on a WEB server 21.

The communication devices 20 may take many forms, such as a personal computer system 20a, a wireless digital phone 20b, a PSTN (Public Switched Telephone Network) phone (not shown), a television provided with Internet access (not shown), or any other devices allowing communication over a network. Of course, the computer system 20a is configured to allow connection to the Internet or to another network, and includes, for example, a modem (not shown) and appropriate software. Similarly, the wireless digital telephone 20b is configured with the Internet or other network access features. In addition, agent servers 12a and 12c may also connect to the hosting agent server 12b (see dashed lines 112′ in FIG. 1), then acting as a channeling device to servers 12a and 12c.

Such communication devices 20 enable a consumer to select one of the services offered on a WEB site accessed to by the Web Server 21.

The WEB server 21 then sends a service request (arrow 102) together with optional information related to the consumer. This consumer information may be already stored in the controller server 14, or input by the consumer during the service selection.

As an alternative to the action 102, the consumer may directly request a service to the controller server 14 (arrow 102′).

The controller server 14 then selects an appropriate agent server among the available agent servers 12, for example 12b, and issues a notice to that agent server 12b (arrow 104).

The selected agent server 12b may then acknowledge the controller server 14 that it is available to proceed with the communication with the consumer activating the communication devices 20, which is embodied here as way of example by the communication device 20a (arrow 106). If not, the controller server 14 reiterates its request to other appropriate agent servers 12 until one is available. If no appropriate agent server 12 is found, the controller server 14 notifies the consumer (via his communication devices 20a) that the requested service is unavailable at that time and may offer him the opportunity to retry later, leave a message or schedule a callback

Once an appropriate agent server 12b has been found and optionally informed about the consumer's request (20a), the controller server 14 sends connection information to the consumer 20a, including connection instructions and information about the agent server 12b taking the request (arrow 108).

The consumer 20a then directly connects to the corresponding agent server 12b (arrow 110) and a bi-directional connection is established (arrow 112).

From the above, it should be understood that the controller server 14 includes routing functionality and allows establishing and managing connections between a consumer's devices 20 and an agent server 12, depending on the availability of the agent server 12.

However, the availability is a theoretical construct determining how many simultaneous consumer devices 20 may connect to the agent server 12, as established based on rules contained by the controller 14.

More specifically, the controller server 14 is configured for receiving a communication request from communication participants, (who are consumers or clients according to this first embodiment), and for establishing a communication link between this communication participant 20 and one of the agent servers 12, which act as communication hubs, as will be explained further hereinbelow.

Alternatively, the system 10 may be configured to allow direct establishment of a communication link between a consumer's communication device 20 and an agent server 12, without involving the controller server 14 as an intermediary.

It is to be noted that, for demonstration purposes, the agent servers 12 and the consumers' communication devices 20 are connected through the Internet via the TCP/IP (Transmission control protocol/Internet Protocol) protocol, and that the communication may be transported on other appropriate protocols

Each of the agent servers 12a, 12b, 12c is configured for managing communication contributions from the different participants of a communication, namely one of the agents operating the agent servers 12a, 12b, 12c and many consumers operating a communication device 20.

Since many consumers or, depending on the application, many communication participants, can be simultaneously connected to each of any of the agent server 12a-12c, each of those agent servers acts as a communication hub. Furthermore, as will be explained hereinbelow in more detail, the agent servers 12 are programmed so as to manage and control some aspects and features of the communication with the consumers' communication devices 20.

More precisely, the agent servers 12 are configured and programmed for sending phonic phrase groups (PPG™s) to the consumers' communication devices 20 and for receiving PPG™s therefrom through the network.

A PPG™ consists of a voice, video and/or text messaging and reply capture. It corresponds to parts of speech (or communication contribution) that should be considered as a whole, i.e. which are not intended to be interrupted. Such parts of speech are often single thought-based phrase groups, usually last only several seconds, and are advantageously punctuated by detectable pauses. A PPG™ may be as large as an entire speech, or as small as a single word. The chirp of a bird could be converted into a PPG™.

It is to be understood that, contrary to what their designation supposes, phonic phrase groups are not limited to computer-readable sound segments. PPG™s may be constructed from any combination of voice, video, electronic document, and/or text relating to a synchronized time frame.

Schematically specking, a PPG™ includes two main parts: data and appended tag(s).

The data segment may be in any computer-readable form traditionally used to communicate an idea, or in any combination thereof. For example, it may include a MPEG (Moving Picture Experts Group) file, including video and voice, any text files, or a combination of a video with an appended text. Of course, other computer media may also be used, such as MP3 (MPEG1 Audio Layer 3), WAV, HTML (HyperText Markup Language), FLASH™, etc.

Considering the above characteristics of a PPG™, an agent server 12 and communication devices 20 comprises components and/or peripheral communication devices (not shown) to capture a communication contribution from the agent (user) operating the communication system. For example, video images may be captured using a computer camera, while the sound may be captured by means of a microphone. Of course, text segments may be inputted by the agent through a conventional keyboard, or captured with a microphone and translated into a text file using voice-recognition software. Since those input devices are believed to be well known in the art, they will not be further described herein.

Therefore, the agent servers 12 are programmed for converting a captured communication contribution into PPG™s. This includes a first step of assembling all the media segments of the captured communication contribution (sound, image, document, and/or text) into a single data element united under a common time frame, and of characterizing the captured communication contribution with tags, including a tag characterizing the common time frame. This also includes a second step consisting in defining the start and the end of the communication contribution in a larger communication exchange. The first step of segment assembling may be done by using variable pointers connecting segments to one another, as it is commonly known in computer art. As will be obvious to people in the art, other assembling methods may be used.

Coming back to the characteristics of PPG™s, tags are digital information appended to a communication contribution to characterize it. As a matter of fact, a PPG™ may be characterized in many ways: according to the originating communication participant, the intended receiver(s) of the PPG™, its time of creation, a context, key-words, clearance, etc. Of course, the nature of a tag is not limited to the above-listed items. Indeed, information may be associated with a communication contribution.

Hence, each agent server 12 is programmed so as to provide the operating agent with a user-interface allowing, among other functions, appending different selected tags to the PPG™ and defining the boundary of the PPG™.

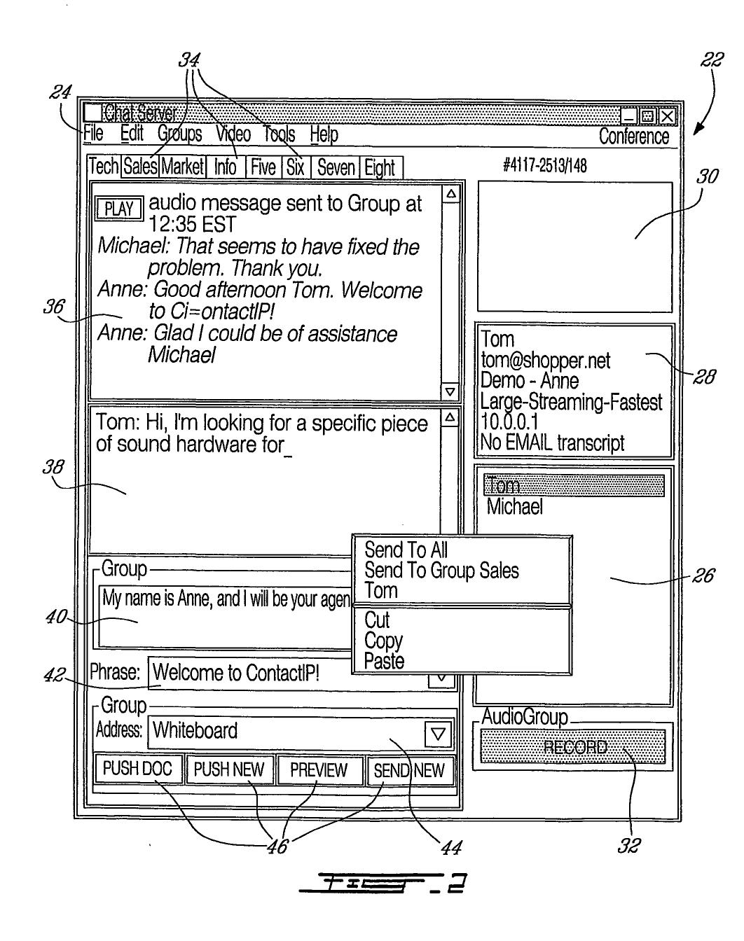

Recording, listening, tracking and distributing the PPG™s is allowed by a user interface 22 of the agent servers 12, which will be described now with reference to FIG. 2. Each communication devices 20 interface may also be enabled with similar features as permitted by its particular architecture.

The user-interface 22 is displayed on a conventional computer monitor connected to the agent servers 12 and operated with conventional input devices such as a keyboard and a mouse. Of course, other input and output devices may be used.

The user-interface 22 includes a variety of interactive visual graphic means, including:

a conventional menu toolbar 24;

a list of connected communication participants 26, allowing the selection of a participant;

a window displaying and altering information about the selected participant 28, including, for example, information about the connection or rules of communication applying specifically to this participant;

a window for displaying and altering video information and PPG™s 30;

a push button 32 for starting the capture of an audio and/or video communication contribution;

a plurality of tabs 34 for associating control and display windows to selected groups of communication participants displaying various information pertaining to this group of participants such as alerting of communication activity actively happening within the group;

a window for displaying and publishing text and audio PPG™s 36;

a window for previewing not yet published PPG™ as they are created but not yet finalized 38;

a text input box 40;

a display box for the text segment of the current PPG™ 42;

a display box for the currently selected document or collaboration tool segment of the PPG™; and

a series of PPG™ selection and editing buttons 46.

Of course, the user-interface 22 may offer other or additional menus and functions to manage PPG™s and append tags thereto.

Information about PPG™s may be displayed on the user-interface 22 using a color code to identify conversation contributions according to the participant or other tags.

Alternatively, the controller server 14 may be programmed to define rules when a communication link is established so as to force certain tags to be appended to the PPG™s to be produced during a future communication, as will be explained hereinbelow. A communication participant with pre-assigned rights and clearance may modify tag-based permissions and restrictions.

In relation to the creation and distribution of PPG™s, the user-interface 22 allow two possible modes: “open channel” and “preview an send”.

1. “Open channel”: According to this mode, PPG™s are sent to the recipient'(s') communication device 20 as soon as they are being created, without regard to content. While using this mode, there is no opportunity for the agent to review and revise the phonic phrase group created.

2. “Preview and send”: The PPG™s may be reviewed before distribution. Then it may be discarded or accepted. This mode minimizes time lags by sending the PPG™ as it is recorded, but only allows playing of the message once it is finally accepted.

As far as playing the PPG™s is concerned, the user-interface 22 as well as may be available on communication devices 20 may support three modes: “open channel”, “play as soon as completely accepted”, and “play on-demand”.

1. The “open channel” mode allows displaying or listening to PPG™s in real-time. As such, each speaker's phonic phrase group is streamed and listened to as soon as the end user receives the phonic phrase group. This is the most interactive-of the three modes, as there is minimal delay between the speaker (the consumer) relaying the message and the listener (the agent) hearing the message. Although these PPG™s are heard instantaneously, they are advantageously recorded in order to produce context, and for latter support during conversation playback.

2. The “play as soon as accepted” mode allows a plurality of people to speak simultaneously. In this mode, the phonic phrase groups are recorded and replayed in the order in which each speaker finishes speaking (or some other order created by the agent server 12). The system captures the PPG™s and their sources, and tags the phonic phrase groups with a record of the time they are completely accepted by the listening system, in order to allow a sequential and possibly chronological replay of all the speakers involved. The agent server 12 will automatically play back these phonic phrase groups in the proper order and will store them for future reference.

3. The “plays only on-demand” mode allows the listener to replay phonic phrase groups in a most controlled and efficient fashion. The decision as to which PPG™s are to be listened to, or as to where to start listening (including which voice(s) of which participant(s) to listen to) is entirely controlled by the agent or if permission is given to the end user.

In the last two modes, the agent is provided with tools programmed in the agent server 12 to optimize the listening experience. Such tools allow, for example, for faster than real time replay, pauses, and shortened breathing time.

It is to be noted that the term “conversation” is used herein in reference to a series of communication contributions performed in a certain context.

In summary, the system 10 allows for the controller server 14 to select, according to the nature of the communication, which of the three above-mentioned modes the listener is allowed to choose from.

The agent servers 12 are programmed to offer options to control the frequency and duration of each PPG™ that may be distributed by any or all participants in the communication. Options to allow for replay of PPG™s in a chronological order, as well as threaded by content and intent by speaker, or ordered by priority, are also included.

The systems 12 and the communication devices 20, may be configured with possible modes for replaying the phonic phrase groups, such as:

1. Replay a specific instance of a PPG™ only.

2. Replay all of the conversations in chronological order, from all of the communication participants.

3. Replay conversations or specific PPG™ from particular participants only (i.e. only listen to and/or watch some parts of the conversations), or conversely exclude certain participants as well as limit the replay to the first x seconds for any or all participants in the conversation, x being a predetermined number.

The communication devices 20 to create PPG™s, initially configured by the controller 14 and then editable by the agent server 12 include methods such as:

1. “Speak at will” creating a PPG™ at any time; and

2. “Speak when prompted”

a. All communication devices prompted for response simultaneously;

b. All communication devices are prompted in a sequence.

Additionally, there are any number of non-chronological settings that may be included with the agent server 12 or consumer's communication devices 20, which are enabled by the controller server 14 so that participants organize and reorganize the discussion in numerous ways, thereby enhancing the overall understanding of any conversation, as well as choosing the particularly important parts of a large group's communication and participating (or simply attending) in a communication at some time other than it occurs.

Of course, each agent server 12 is configured to distribute PPG™s to selected participants (clients 20 in the case of the embodiment of FIG. 1) among all communication participants connected to the communication hub formed by these agent servers 12. The distribution may be done through the controller server 14 or directly to each selected participant.

The selection of recipients for each PPG™ may be predetermined based on various criteria, or is performed based on tags. This is described in more detail hereinbelow by referring to another embodiment.

Alternatively, the agent servers 12 may be autonomous systems configured with expert systems enabled to produce and distribute PPG™s, following certain requests received from the consumer's communication devices 20.

The communication devices 20 are provided with user-interfaces and programmed with other appropriate functions similar to those described for the agent servers 12, allowing the consumers to convert conversation contributions into PPG™s and to communicate PPG™s with the agents similarly to what has been described hereinabove for the agent servers 12.

Of course, the functionality of the communication devices 20 may vary depending on their computational capabilities and multimedia features, as well as on the restriction imposed by the controller server 14 and/or the agent servers 12 upon connection. The communication devices 20 advantageously scale to deliver the PPG™s that are optimal for the device 20. For example, the client's communication device 20 may be configured only to play sounds without allowing many interactions by the client. Of course, the agent server 12 is informed on the nature and features of the consumer's communication device 20 when the communication is established so that PPG™s are created accordingly.

It should be understood that even though the agent servers 12 have been described as computer servers exchanging information on a network implemented under the TCP/IP protocol, other protocols may also be used, such as 3G (Third Generation), WAP, etc. Additionally, gateways 18 (see FIG. 1) may allow implementation of the system 10 on a heterogeneous network.

Furthermore, the controller server 14 may serve two primary purposes in addition to that of establishing connections between clients 20 and agents 12: personalization of the communications and reporting.

For those purposes, the archive server 16 is connected to the controller server 14 to store collected information by the controller server 14. The archived information includes consumer and agent-related information, communications reports, etc.

This archived information allows personalization of the user interfaces and establishment of rules to manage communication between the agents and clients, as will be described hereinbelow.

The controller server 14 may also use the archived information to provide communication reports to the agents or to the service provider.

The controller server 14 allows the permanent saving of conversations for later and/or historic review, and for optimization of the playback, as determined by the participants 12 (agent servers) and 20 (client). These conversations may be categorized and retrieved for replay in many different schemes using voice recognition and/or human management tools in order to achieve relevant categorizations. The controller server 14 may also use voice recognition and/or human management tools in order to create selection criteria for the retrieval of communication portions.

Of course, these tools may be shared with the agent servers 12 and communication devices 20 upon request.

Alternatively, the controller server 14 may be provided with an adequate storing capacity and data management software to archive the information.

In the embodiment illustrated in FIG. 1, one of the system gateways 18 is a WAP (wireless application protocol) gateway, allowing the WAP digital phone 20b to be connected to any of the agent servers 12a-12c.

Of course, the system 10 may include other system gateways 18 to allow different types of devices, including so-called “dumb devices”, such as telephones operating under a public switched telephone network.

Since gateways and archive servers are believed to be well known in the art, they will not be described herein in more detail.

The controller server 14 may either remain connected to both the agent server 12b and the consumer device 20a (to come back to the previous example) at all times during the communication in order to control some aspects of the communication, or may disconnect after establishing the connection, and exchange information for archiving at a later time.

In the case where the controller server 14 remains connected during the whole communication, some of the communication contributions tagging may be performed by either the controller server 14 or the agent server 12b, depending on the applications.

The system 10 allows any communication participant to exchange specific phonic phrase groups during a conversation, without having to download or install any plug-ins or players. This is advantageously made possible by the use of conventional applications widely implemented in actual personal computer systems, such as conventional web browser, by remotely pushing the applications, and by allowing the management of PPG™s to the communication devices 20 via a text-based computer language such as Java™ or HTML (Hypertext Markup Language). Although not required, consumer devices 20 may be enhanced by dedicated software that is to be installed.

The system 10 avoids time limitation on communications by providing tools to capture and distribute communication segments or contributions.

In addition, the system 10 allows the moderation of any number of simultaneous conversations via the controller server 14 or one of the agent servers 12a-12c. The controller server 14 or the agent servers 12 may set up default and possibly changeable rules for the communication participation in any communication. These rules can be emulated in person forums such as classrooms, town halls and conference rooms. These rules may enforce or prohibit participation in any part of a conversation or in its entirety. These rules may also be set as default, set on a group level or imposed on a single participant.

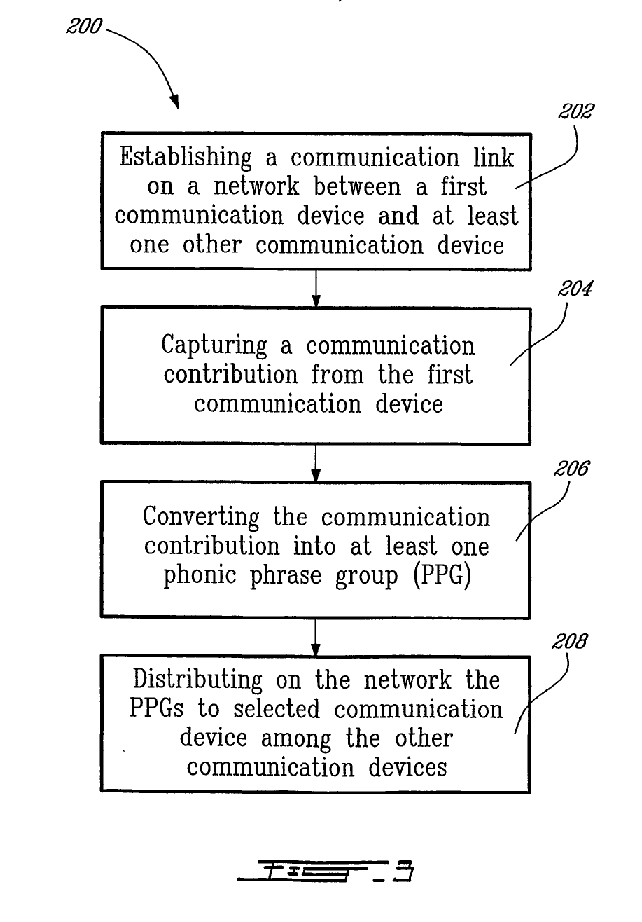

For clarity purposes, a summary of a network-assisted communication method 200, according to a preferred embodiment of the present invention, is presented in FIG. 3.

The steps of the communication method 200 comprise:

establishing a communication link on a network between a first communication device and at least one other communication device (step 202);

capturing a communication contribution from the first communication device (step 204);

converting the communication contribution into at least one phonic phrase group (PPG™) (step 206); and

distributing on the network the PPG™s to selected communication device among the other communication devices (step 208).

It must be understood that, even though the system 10 has been described in relation to FIGS. 1 and 2 with reference to a consumer's service, a network-assisted communication system according to the present invention may also allow for network-based sales services, peer conferences, as well as hierarchical or peercommunications such as seminars, classes, sales or business meetings, interest communities, etc. to be implemented.

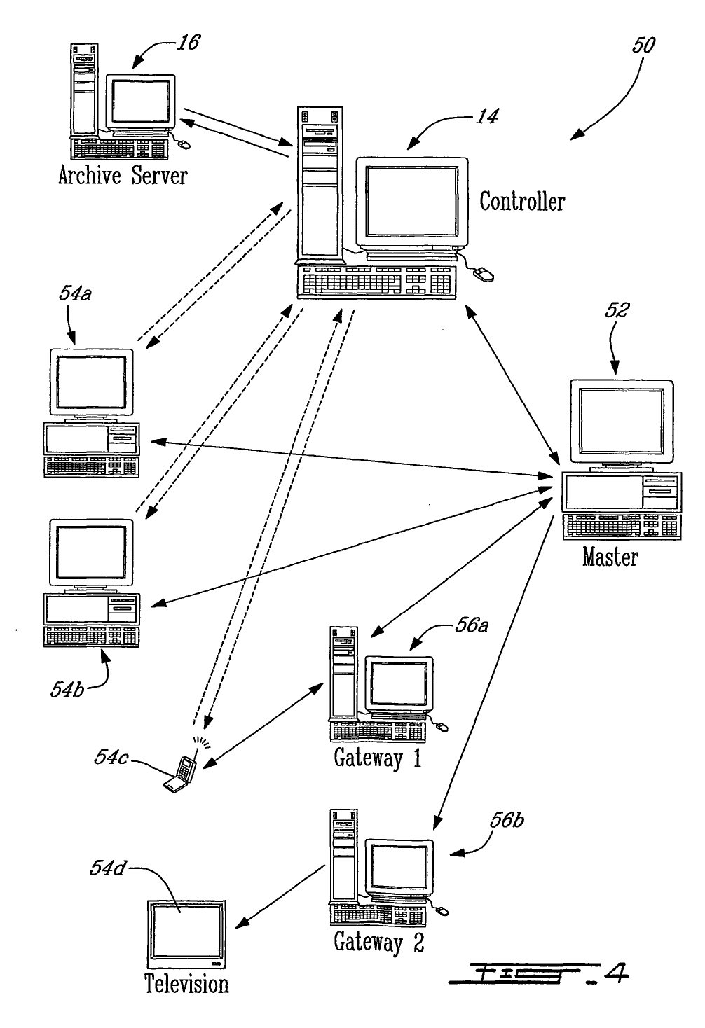

In order to further illustrate the various possibilities of the network-assisted communication system according to the present invention, FIG. 4 shows a network-assisted communication system according to a second embodiment of the present invention. The communication system 50 allows implementing a master class over the network.

In this embodiment, the terms “professor”, “teacher”, and “student” are used to illustrate the hierarchical nature of the communication and of course allows for other relationships to use this embodiment, including manager and workers or even game show hosts and game participants.

Since the communication system 50 is similar to the system 10 previously described, only the structure of the resulting network and some important differences will be described herein in further detail.

The communication system 50 comprises a controller 14, a communication hub 52 (master's system) in the form of a computer device remotely connected to the controller 14 (remotely or not) via a network, an archive server 16 connected to the controller 14, first students' communication devices in the form of a permitted computer based communication device 54a-54b (only two shown), a second communication device channel in the form of a wireless digital phone 54c connected to the masters system 52 through a first gateway 56a, and a television set 54d connected to the master's system 52 through a second gateway 56b.

Alternatively, the gateways 56 may be connected to the controller 14 so that the communication devices 54c-54d may connect to the master's system 52 via the controller 14.

Similarly to the embodiment of FIG. 1, the communication link between devices 54 of the class participants is established via the controller 14 (dashed lines in FIG. 4).

All the participants to the class may be equipped with agent systems 52 and communication devices 54 enabling them to also manage PPG™s as discussed hereinabove.

Of course, a student using the wireless digital telephone 54c may only access the sound segments of the PPG™s distributed by the master, and may only issue questions using sound segments.

A student equipped with the television 54d, which is considered a dumb device, since it does not allow sending PPG™s, may not interact with the rest of the class participants but may witness the communication.

A master (professor) may use the system 52 to restrict questions only to certain students, or to define PPG™s as large video segments therefore preventing questions before the end of such PPG™s.

The students may review the PPG™s distributed by the professor, as well as questions and interactions from other students.

The level of each student may be determined with the use of appropriate tags. Indeed, each student may select the level of the course that corresponds to its experience in the subject. The master could then select the recipients of each PPG™ based on a level tag.

In addition, a PPG™, sent in answer to a PPG™ corresponding to a question by one of the students, may be replied to only by the student who asked the question. Again, this could only be done by selecting, with or without using a tag, the author of the question as a recipient for the corresponding PPG™.

Of course, other features, such as those described with reference to FIG. 1, may also be provided with the system 50.

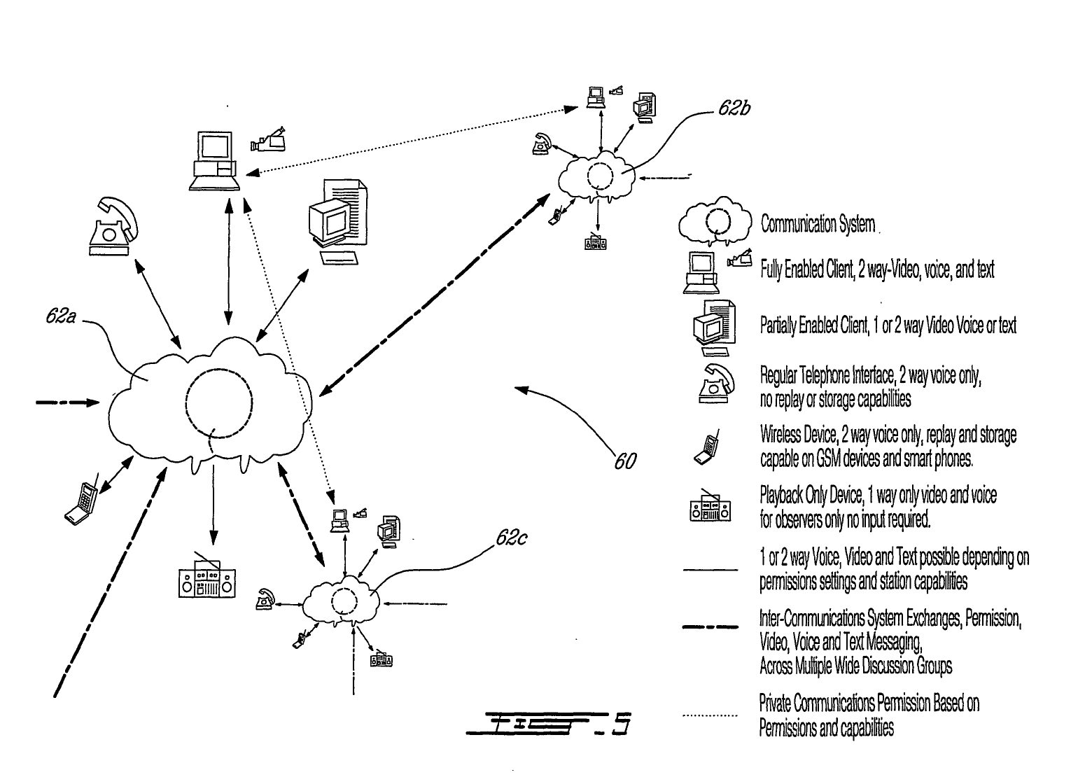

Finally, FIG. 5 illustrates a third embodiment of a network-assisted system 60, according to the present invention.

FIG. 5 shows a plurality of network-assisted systems 62 according to the present invention, each similar to the system 10 and the system 50, but further comprising other systems 62 connected thereto as communication participants. Communications through such systems 62, when enabled, will replicate across all interconnected systems 62,

Applications of the system 60 include discussion groups. It is to be noted that the use of a user-interface equipped with tabs, such as tab 34 in FIG. 2, may allow selection of one of the discussion groups.

Although the present invention has been described hereinabove by way of preferred embodiments thereof, it can be modified without departing from the spirit and nature of the subject invention, as defined in the appended claims.

What is claimed is:

1. A network-assisted communication method comprising:
establishing a communication link on a network between a first communication device and at least one other communication device;
capturing a communication contribution from the first communication device; and
converting said communication contribution into at least one phonic phrase group (PPG™) to be distributed on said network to said at least one other communication device; said at least one PPG™ including a data segment and at least one tag.

2. A network-assisted communication method as recited in claim 1, wherein said at least one other communication device includes a plurality of other communication devices;
whereby allowing a plurality of communications around said first communication device and said plurality of other communication devices.

3. A network-assisted communication method as recited in claim 1, wherein said at least one tag characterizes said at least one other communication device.

4. A network-assisted communication method, as recited in claim 1, wherein said at least one tag is characterized by an attached feature selected from a time of creation of said tag, a communication context, a PPG™ clearance, and a keyword.

5. A network-assisted communication method as recited in claim 1, wherein said establishing a communication link on a network includes connecting said at least one other communication device to said first communication device.

6. A network-assisted communication method, as recited in claim 1, wherein said establishing a communication link on a network includes:
said at least one other communication device sending a communication request to a controller;
said controller issuing a notice to said first communication device upon receiving said request;
said controller sending connection information to said at least one other communication device; and
said at least one other communication device connecting to said first communication device.

7. A network-assisted communication method as recited in claim 6, wherein said communication request is sent to said controller via a server connected to the network.

8. A network-assisted communication method as recited in claim 1, wherein said capturing a communication contribution from the first communication device yields at least one media segment; said converting said communication contribution into at least one PPG™ includes assembling said at least one media segment into a single data element united under a common time frame.

9. A network-assisted communication method as recited in claim 8, wherein at least one tag characterizes said common time frame.

10. A network-assisted communication method, as recited in claim 1, wherein said converting said communication contribution into at least one PPG™ further includes defining a start and an end of the communication contribution during a larger communication exchange.

11. A network-assisted communication method as recited in claim 1, further comprising: archiving distributed PPG™s for later retrieval.

12. A network-assisted communication system comprising:
at least one communication hub to be connected to a network for sending phonic phrase groups (PPG™s), and for receiving PPG™s from at least one communication device through said network; said communication hub being configured to convert a PPG™ into at least part of a communication contribution, and to convert a communication contribution into at least one PPG™; said at least one PPG™ including a data segment and at least one tag.

13. A network-assisted communication system as recited in claim 12, wherein said at least one communication device is another communication hub.

14. A network-assisted communication system, as recited in claim 12, wherein said at least one communication hub is provided with a user-interface for converting said communication contribution into at least one PPG™.

15. A network-assisted communication system as recited in claim 14, wherein said user-interface allows defining time boundaries of said at least one PPG™.

16. A network-assisted communication system as recited in claim 12, wherein said at least one communication hub being further configured to send PPG™s according to at least one of the mode comprising “an open channel mode” and “a preview and send mode”.

17. A network-assisted communication system as recited in claim 12, wherein said at least one communication hub being further configured for displaying PPG™s.

18. A network-assisted communication system as recited in claim 17, wherein said at least one communication hub being further configured for displaying PPG™s, according to at least one of the mode including an “open channel” mode, a “play as soon as accepted” mode, and a “plays only on demand” mode.

19. A network-assisted communication system as recited in claim 12, wherein said data segment of said at least one PPG™ includes at least one text, image, sound, video and FLASH™ portion.

20. A network-assisted communication system as recited in claim 12, wherein said at least one of said communication hub and said communication device includes a means to capture a communication contribution connected thereto.

21. A network-assisted communication system as recited in claim 20, wherein said means to capture a communication contribution is in the form of a peripheral communication device.

22. A network-assisted communication system as recited in claim 21, wherein said peripheral device is selected from a camera, a microphone and a keyboard.

23. A network-assisted communication system as recited in claim 12, wherein at least one of at least one communication device and said controller is configured using a text-based computer language.

24. A network-assisted communication system as recited in claim 12, wherein said communication device is selected from a wireless digital telephone, Public Switched Telephone Network (PSTN) telephone, a television provided with Internet access, and a personal computer provided with network capability.

25. A network-assisted communication system as recited in claim 12, wherein said at least one communication device is connected to said communication device via a gateway.

26. A network-assisted communication system as recited in claim 25, wherein said at least one communication device is a dumb device.

27. A network-assisted communication system as recited in claim 26, wherein said dumb device is selected from a group consisting of a telephone configured for a public switched telephone network, and a television.

28. A network-assisted communication system as recited in claim 12, wherein the network is implemented under the TCP/IP (Transmission control protocol/Internet Protocol) protocol.

29. A network-assisted communication system as recited in claim 12, wherein the network is a heterogeneous network.

30. A network-assisted communication system as recited in claim 12, further comprising:
a controller connected to the network for receiving a communication request from said at least one communication device, and for establishing a communication link between said at least one communication device and said communication hub.

31. A network-assisted communication system as recited in claim 30, further comprising an archive server connected to said controller; said archive server being configured for storing archive information.

32. A network-assisted communication system as recited in claim 31, said controller including a data management software.

33. A network-assisted communication system as recited in claim 31, wherein said archive information includes PPG™s.

34. A network-assisted communication system as recited in claim 31, wherein said controller is further configured to provide communication reports to at least one of said communication hub and said at least one communication device.

35. A network-assisted communication system as recited in claim 30, wherein said controller is configured to define rules when said communication link is established for appending predetermined tags to at least one of the received and sent tags.

36. A network-assisted communication system as recited in claim 35, wherein said rules allow to implement over the network at least one from peer conferences and hierarchical communication.

37. A network-assisted communication system as recited in claim 36, wherein said hierarchical communication is selected from a seminar, class, town hall, and business meeting.

38. A user-interface for a network-assisted communication system comprising:
interactive visual graphic means for capturing at least one multi-media segment from a communication contribution issued from a first communication participant;
interactive visual graphic means for converting said communication contribution into at least one phonic phrase group (PPG™), including means for assembling multi-media segments and for appending tags that characterize said communication contribution;
interactive visual graphic means for sending said at least one PPG™ to at least one other communication participant through a network;
interactive visual graphic means for receiving other PPG™s from said at least one other communication participant through said network; and
interactive visual graphic means for displaying at least one of said at least one PPG™ and said other PPG.
